(19) United States
(12) Patent Application Publication
(10) Pub. No.: US 2011/0010615 A1
(43) Pub. Date: Jan. 13, 2011

(54) METHOD FOR DISPLAYING INFORMATION GENERATED BY A CLIENT

(75) Inventors: Walter Dees, Eindhoven (NL); Paul Shrubsole, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindohoven (NL)

(21) Appl. No.: 12/933,693

(22) PCT Filed: Mar. 17, 2009
(86) PCT No.: PCT/IB2009/051082

§ 371 Date: Sep. 21, 2010

(30) Foreign Application Priority Data
Mar. 21, 2008 (EP) 08153176.6

(51) Int. Cl. G06F 17/00

(52) U.S. Cl. 715/241

(57) ABSTRACT

The invention relates to a method for displaying information generated by a client connected to a communications network. The invention also relates to an apparatus for operating as a client to a server, whereby the server is connected to a communications network. One of the possible solutions for preventing the switching by the user between display renderings is to employ scripting, such as javascript. However, this can lead to security and privacy concerns. The method of the invention comprises retrieving and displaying a first information content comprising a placeholder; retrieving a second information content comprising appearance definitions; retrieving a third information content from the client (10), the third information content being generated and controlled by the client; displaying the third information content at a position in the display determined by the placeholder; and displaying the third information content according to the appearance definitions. By separating the functional content from the ‘look and feel’ content, the functional content may be provided by the client without it being visible or accessible to the service provider, but still allowing the service provider to maintain a consistent ‘look and feel’.

### FIELD OF THE INVENTION

The invention relates to a method for displaying information generated by a client connected to a communications network, and to a computer program comprising program code means for performing all the steps of the method, when said program is run on a computer.

The invention also relates to a method for supplying information content to a client connected to a communications network.

The invention also relates to an apparatus for operating as a client to a server, whereby the server is connected to a communications network.

### BACKGROUND OF THE INVENTION

The use of networked devices is becoming more and more prevalent. For example, there is currently a lot of development in the area of home-networks which provide remote user interfaces for consumer devices in UPNP (Universal Plug and Play) networks. Such a network may allow the user to remotely control applications on other UPnP devices over a UPnP home network, and may also allow the user to interact with Internet Services using consumer devices that are connected to the Internet. One of those interactions may be the use of Internet services which allow content, such as movies, to be downloaded.

The multitude of suppliers of Internet services, the different types of services and the multitude of consumer device suppliers means that it is preferable to standardize the communication protocols and interfaces as much as possible to provide the best experience for the user.

One such standard, suitable for home-networks is CEA-2014 or Web4CE, a Consumer Electronics Association (CEA) standard. The standard specifies UPnP services and a HTML-based standard called CE-HTML that is aimed at remote user interfaces for consumer devices in UPnP networks. Web4CE has two main applications: first it will allow consumers to remotely control applications on other UPnP devices over a UPnP home network. Second it will allow consumers to interact with Internet Services using consumer devices that are connected to the Internet. The user interaction may take place using just the remote control, the keys or the touch screen of the device containing a CEA-2014 compatible browser, e.g. a Media Adaptor, a TV or a mobile phone.

The CEA-2014 Web4CE standard allows a UPnP device or an Internet Service (acting as a CE-HTML web server) to transport a graphics-based interactive user interface in the form of CEA-2014 compliant HTML pages. Web4CE gives UPnP device vendors as well as authors of Internet Services full control not only over what functions can be remotely controlled but also over the “look and feel” of the user interface that will be shown to the consumer. The “look and feel” are the aspects perceivable to the user and are not related to functional properties of the user interface.

The connected UPnP digital home allows users to access a variety of features and applications from various products in the home. In addition, consumer products are extending their functionality by providing direct access to Internet-based News & Entertainment Services delivered to the home by a service provider over broadband networks such as ADSL and cable.

A major component of Web4CE is the CE-HTML profile that uses XHTML content to define user interfaces that can be rendered on screens with different resolutions and sizes ranging from HDTV screens to mobile-phone displays. The use of XHTML as the base technology means content can be authored and rendered using widely accepted and existing web technologies and toolkits. In addition, this makes it very easy and cost effective for HTML tool suppliers and software vendors to support CE-HTML.

CE-HTML is displayed using a CE-HTML browser. An important part of a browsing experience is interaction between displayed information inside the browser (e.g. a CE-HTML page) and local client side functionality, such as a download manager for downloading content, such as A/V (audio/video) content. This local client side functionality typically displays its information (status, progress, etc.) through a local native UI, and is displayed and controlled completely independently from the displayed information inside the browser.

### SUMMARY OF THE INVENTION

It is an object of the invention to provide a method for displaying information generated by a client connected to a communications network.

According to a first aspect of the invention the object is achieved with the method for displaying information generated by a client connected to a communications network, comprising retrieving a first information content from a server over the communications network, the first information content comprising a placeholder; displaying the first information content on a display; retrieving a second information content from the server, the second information content comprising appearance definitions; retrieving a third information content from the client, the third information content being generated and controlled by the client; displaying the third information content at a position in the display determined by the placeholder; and displaying the third information content in the display according to the appearance definitions.

According to an aspect of the invention, a method is provided wherein the method further comprises retrieving instructions from the server; and executing the instructions to retrieve the second information content from the server.

### BRIEF DESCRIPTION OF THE DRAWINGS

These and other aspects of the invention are apparent from and will be elucidated with reference to the embodiments described hereinafter.

In the drawings:

FIG. 1 shows a method for supplying information content to a client connected to a communications network,

FIG. 2 depicts a method for displaying information content generated by a client connected to a communications network using instructions,

FIG. 3 shows a further method for supplying information,

FIG. 4 depicts another for supplying information,

FIG. 5 depicts an example of the information displayed by a download manager according to the methods of FIGS. 2, 3 and 4.

The figures are purely diagrammatic and not drawn to scale. Particularly for clarity, some dimensions are exaggerated strongly. Similar components in the figures are denoted by the same reference numerals as much as possible.

### DETAILED DESCRIPTION OF THE PREFERRED EMBODIMENTS

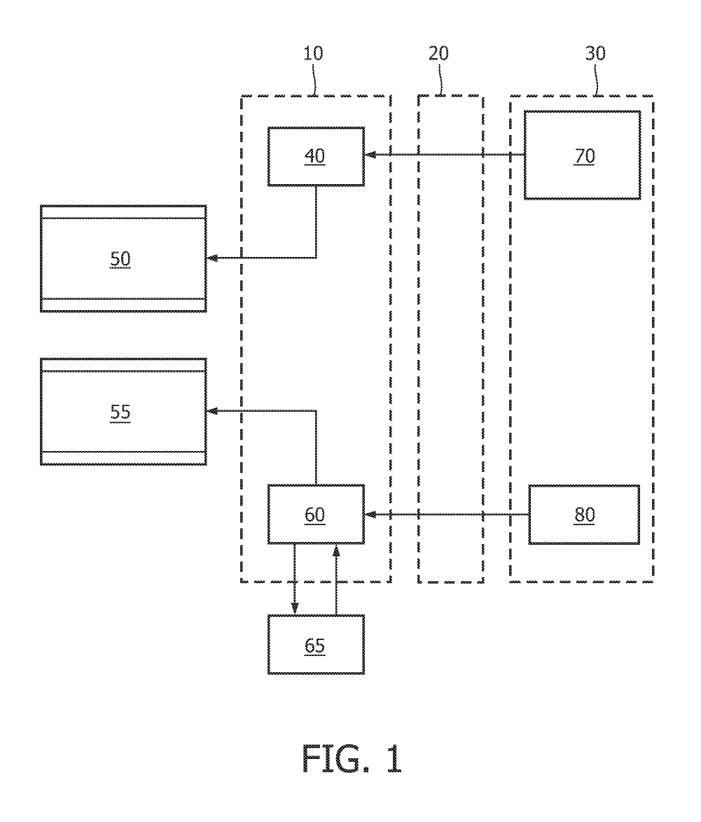

FIG. 1 depicts a client (10) such as a consumer device, connected to a communications network (20), such as a home network. A server (30) is also provided connected to the same network (20). The server (30) may be comprised in a second consumer device, or any device in contact with the communications network (20).

The system of FIG. 1 is configured to permit a user to download content (80), such as movies, from a content provider who has made the content (80) available on a server (30).

The client (10) is provided with a storage device (65) so that the content may be accessed, for example loaded and played, by applications running locally on the client (10). To facilitate the download functionality, the client (10) may be provided with a local player (40) application for displaying information content (70) from the server (30), and a download manager (60).

For example, the information content (70) may provide access to an environment where the content (80), such as a movie, may be selected for download. The environment is provided by a service provider. Typically, the local player application (40) is a browser and the information content (70) comprises a markup language such as HTML, CE-HTML, XML or SVG.

During operation the local player application (40) retrieves information content (70) from the server (30), and displays it (50) to the user. When the user has found content (80) that he wishes to download, the download application (60) is executed to retrieve the content (80) from the server (30). The download application (60) displays (55) the status of the download to the user.

Status information which may be relevant when a download manager (60) may include:

the download status, for example, connecting, in progress, paused, interrupted, completed;

the download progress, for example 0, 25, 50, 75, 99%;

the expected time to complete;

the storage capacity of the storage device (65); and

the remaining free storage capacity, for example, 10, 20, 30, 40%.

Typically, the display (50) by the browser (40) and the display (55) by the download manager (60) are rendered separately by the client (10). Once the download has started, the only way to monitor the status of the download would be by letting the user switch back and forth between the browser rendered display (50) and the download manager rendered display (55). This is a particular problem when operating according to the CEA-2014 standard because it has been decided to give the service provider full screen control over the browser. This switching between display renderings then requires the user to switch between full-screen windows, which makes the user experience less enjoyable.

An additional problem is that the displays are provided by two different applications, which means that the “look and feel”, i.e. the user-perceivable aspects of the information when it is displayed to the user, of these displays may differ considerably, also making the user experience less enjoyable.

Similar problems arise when other local applications are executed by the client, such as:

DRM-agent. States to be displayed may include license expired, connecting to license server, validating license;

Personal Video Recorder (PVR) manager. States to be displayed may include recording started, remaining free storage, indicating content has been watched in a list by graying out one of the members of the list;

Personal TV channel manager. States to be displayed may include favorites, names of content to be recorded, names of content watched, and user profile, and

Control interface for the device running the client. Controls to be displayed may included standby, play, rewind, fast forward, skip etc.

It will be apparent to the skilled person that these applications may be combined as required, for example the download manager and the DRM-agent, and that the invention may be applied to other similar applications running on a client.

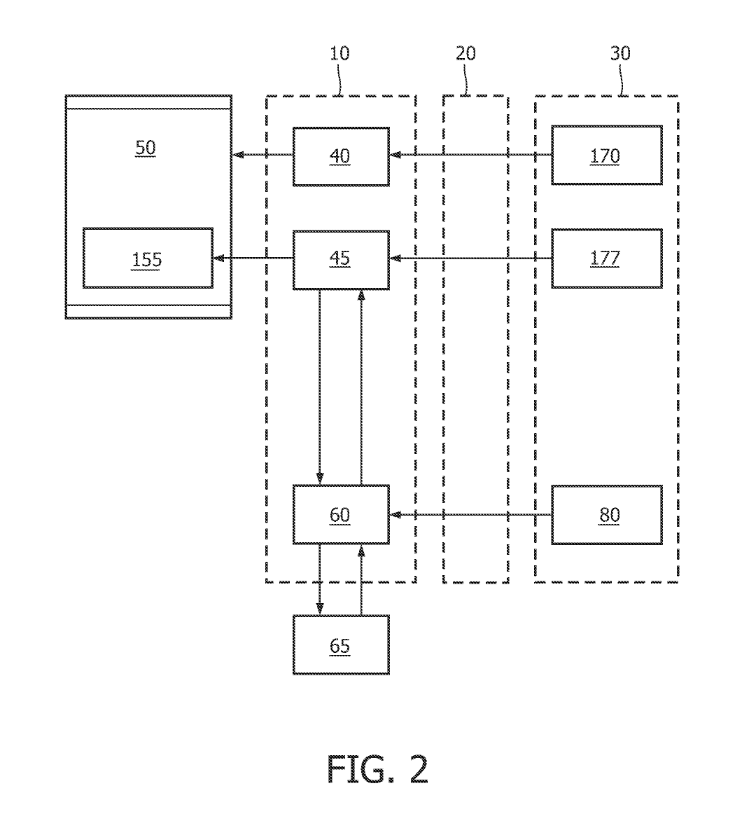

FIG. 2 depicts a method for displaying information generated by a client (10) connected to a communications network (20), which addresses the problems mentioned above. The method of FIG. 2 is the same as the method of FIG. 1, except for the additional aspects described below.

The client (10) is provided with an engine (45), such as javascript, for executing suitable instructions (177) which may be retrieved from the server (177). The engine (45) may integrated into the browser application (40), in which case the instructions (177) may also be integrated into the information content (70).

The engine (45) interfaces with the download manager (60) to retrieve status information, and the engine (45) displays (155) the status information from the download manager (60) simultaneously with the display (50) by the browser (40) of the information content (170).

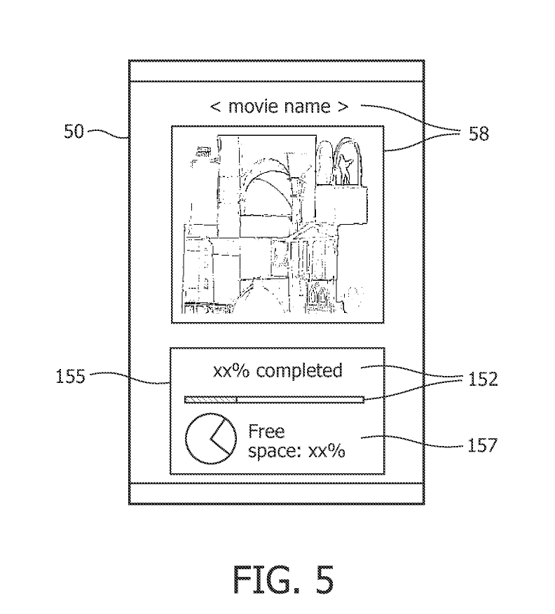

FIG. 5 shows an example of status information which may be displayed to the user when the methods of FIGS. 2, 3 and 4 are performed. The display (50) by the browser (40) comprises content information (58) such as the name of the movie or an image of the poster for the movie. The display (155) by the engine (45) comprises the status information appropriate for the download manager, such as download state and progress (152) and storage free space (157).

As the download progresses, the engine (45) retrieves the status information from the download manager (60) and dynamically renders the display (155) accordingly to give the current values of the states shown.

There are a number of disadvantages to the method of FIG. 2:
1. In order for it to operate correctly for the multitude of combinations between client (10) provided as a consumer device and the service providers, the instructions (177) would preferably be standardized. For example, when using javascript, extensions may be defined such as getDownloadStatus( ), getDownloadProgress( ), getExpectedDownloadTime( ) to query the client device about the current status. However having a lot of new javascript APIs (Application Programming Interfaces) to deal with these extensions. may result in a very complex standard like DVB-HTML;
2. Using instructions (177), such as javascript, to dynamically render the download display (155) may incur serious performance penalties, and puts an extra burden on the client (10);
3. In certain circumstances, it is desirable to disable scripting. For example, to prevent undesired control by the server of a pop-up notification window, scripting may be disabled by default so that, for example, the notification may be made to disappear after a period of time;
4. The instructions (177) are provided by the service provider. Executing these instructions (177) on the client (10) exposes the client (10), and the device it is running, to the server (30). This raises both security and privacy concerns—security because the engine (45) blindly performs the instructions retrieved (177) from the server giving the server (30) access to the client device and, for example, the file system of the storage device (65).

Privacy is an issue because some of the information may be sensitive. What is sensitive depends upon the local application being used—for example:

if a PVR is running on the client (10), the title of the program currently being recorded (155);

for a personal TV channel manager, the title of the content currently being watched;

for a DRM-agent, the number of license validation attempts.

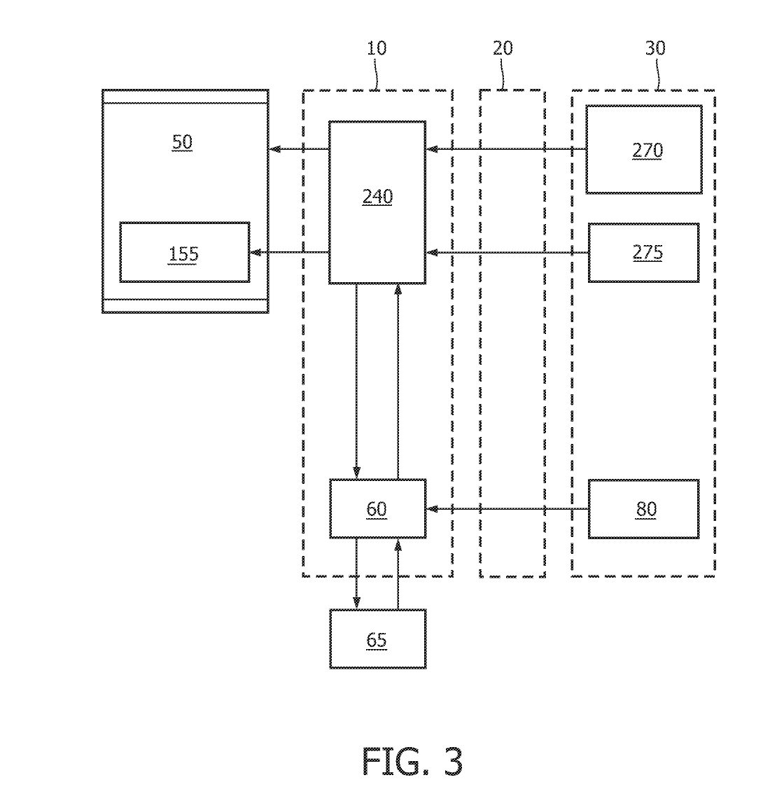

The method for displaying information depicted in FIG. 3 addresses the problems associated with the method of FIG. 3. The method of FIG. 3 is the same as the method of FIG. 1, except for the additional aspects described below.

The client (10) is provided with a player, such as a browser (240), for displaying a first information content (270), such as HTML. The browser (240) interfaces with the download manager (60) to retrieve status information, and the browser (240) displays (155) the status information from the download manager (60) simultaneously with the display (50) by the browser (240) of the information content (170). The browser (240) is also configured to retrieve a second information content (275) from the server (30). The second information content (275) may be separate, be integrated into the first information content (270) or a combination thereof.

The first information content (270) comprises a placeholder, which is used to determine the position of the display (155) of the download status. The second information content (275) comprises definitions relating to appearance, such as style definitions, which the browser can apply when displaying (155) the download status.

During operation, the browser (240) retrieves both the first (270) and second (275) information contents. The browser (240) also retrieves status information from the download manager (60). This download status information is displayed (155) at a position determined by the placeholder, and according to the appearance definitions.

In this way, information from the local application, in this case the download status, is embedded into the browser display (50) in a manner under control by the client without the server (30) being able to determine what is being displayed. The influence of the server (30) is limited to how the download status appears in the display and its position, so that a consistent “look and feel” may be maintained.

The appearance definitions provided as part of the second information content (275) may be, for example, style definitions which the browser understands, images, such as background images, and combinations thereof. It may also include suggestions of which states need to be displayed.

Style definitions may comprise HTML style definitions. These may be provided as style tags within the first information content (270), or a separate style sheets, or as a combination thereof.

If only a limited number of states such as buy, download, download again are to be displayed, then the appearance definitions may comprise images for each of these states—i.e. an image of the appropriate word superimposed on the appropriate background. Such a limited number of states may also be applicable if client-generated errors are to be displayed.

If the first information content (270) comprises HTML, the placeholder may comprise a HTML <object> tag:

### Example 1 HTML Code Source—<Object> Placeholder

<object id=“01” type=”application/download”>
<param name=“State1” value=“Style1” />
</object>

If the second information content (275) is integrated into the first information content (270), the appearance definitions may comprise a HTML <style> tag:

### Example 2 HTML Code Source—<Style> Tag Appearance Definitions

<style >
#01
.Style1
{
background-color: #FF0000;
font-size: 20pt
}
</style>

If the browser (240) retrieves the parameter State1 from the download manager (60), the first information content (270) comprises the <object> tag placeholder (example 1) and the <style> tag appearance definitions (example 2), the appearance definition Style1 will be applied when State1 is displayed (155), i.e. State1 will appear with a red background color, and a font size of 20 pt.

Alternatively, the appearance definitions may be wholly or partly comprised in CSS-style sheets, in which case the first information content (270) will comprise a HTML link tag so that the browser (240) may retrieve the second information content (275):

### Example 3 HTML Code Source—<Link> Tag

<link rel=“stylesheet” type=“text/css” href=“appearance.css”/>

The second information content (275) may be a CSS-style sheet named appearance.css, comprising the appropriate appearance definitions. For example, the appearance definitions may comprise style attributes:

### Example 4 HTML Code Source—Style Sheet Appearance Definitions

#01
.Style1
{
background-color: #FF0000;
font-size: 20pt
}

If the browser (240) retrieves the parameter State1 from the download manager (60), the first information content (270) comprises the <link> tag (example 3) and the <param> tag placeholder (example 1) and the second information content (275) comprises the style sheet appearance definitions (example 4), the appearance definition Style1 will be applied when State1 is displayed (155), i.e. State1 will appear with a red background color, and a font size of 20 pt.

Alternatively, the placeholder may be defined in the first information content (270) using:

a HTML <div> tag, using a pre-defined CSS class definition to be added to the standard.

### Example 5 HTML Code Source—<Div> Tag Placeholder

<div id=“d1” class=“download”/>

a HTML <iframe> tag. However, this requires a local URI scheme, or a URI scheme to be predefined:

### Example 6 HTML Code Source—<iframe> Placeholder

<iframe id=“d1”class=“”src=“download”/>

an <object> tag with a MIME type or class for each application state, instead of its conventional use for each application. However, this would require a multitude of MIME class definitions to be added to the standard.

### Example 7 HTML Code Source—<Object> Tag MIME Type Placeholder

<object id=“01” type=”application/download_in_progress” < /object>
<object id=“02” type=”application/download_completed” < /object>

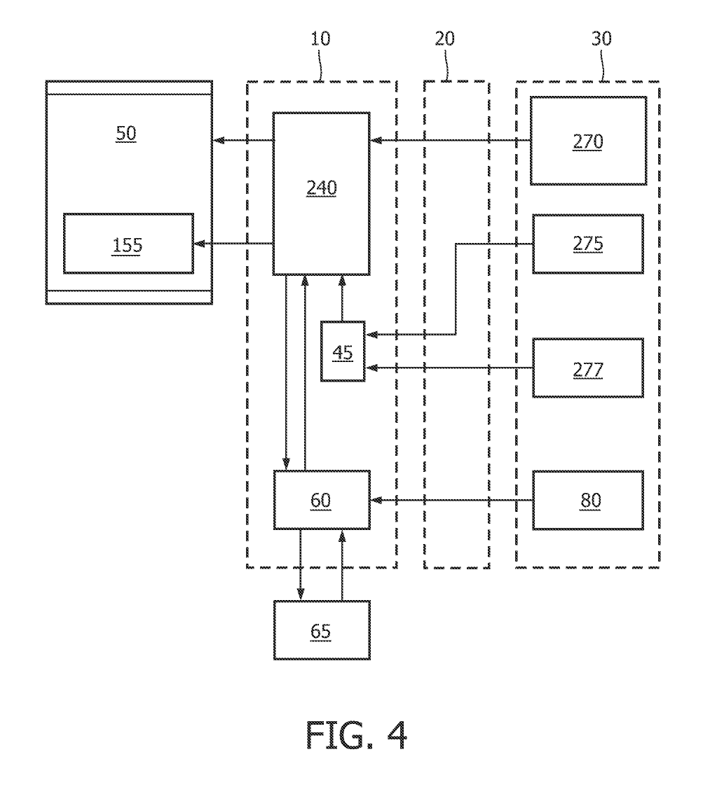

An alternative method is depicted in FIG. 4, which is the same as the method of FIG. 3, except for the additional aspects described below.

The client (10) is provided with an engine (45), such as a javascript engine, which may be integrated into the browser (240) or be a separate application. The engine (45) bis configured to retrieve instructions (277) from the server (30). The engine (45) is further configured to retrieve the second information content (275) by executing the instructions (277), and to provide the browser (240) with the second information content (275).

During operation, the instructions (277) are retrieved from the server by the engine (45), executed causing the engine (45) to retrieve the second information content (275) and to pass the second information content (275) to the browser (240).

The engine (45) may be integrated into the browser application (240), in which case the instructions (277) may also be integrated into the information content (270) using a <script> tag to indicate where the appearance definitions may be retrieved. This may be done using a URL of an image or a stylesheet. The following example uses a script to retrieve the stylesheet of example 4:

### Example 8 HTML Code Source—<Script> Tag

<script>
styleDownloadStates(“connecting”, appearances.css,
“downloading”, appeances.css, ...)
</script/>

If the browser (240) retrieves the parameter State1 from the download manager (60), the first information content (270) comprises the <script> tag (example 8) and the <param> tag placeholder (example 1) and the second information content (275) comprises the style sheet appearance definitions (example 4), the appearance definition Style1 will be applied when State1 is displayed (155), i.e. State1 will appear with a red background color, and a font size of 20 pt.

As the embodiment of FIG. 4 requires instructions to be retrieved and executed, the security concerns do not apply, since the engine does not expose the functionality directly, rather leaves it to the local client functionality to render the display.

It may also be advantageous to configure the client (10) so that it gives an acknowledgement to the server (30) that the appearance definitions have been applied. By providing exchange capabilities at runtime, mistakes such as displaying a white textual label on a white background may be prevented.

Although the method according to the invention provides a high degree of flexibility, it may be advantageous to restrict the possible appearance definitions to relatively few choices, such as only background color and font size.

One of the problems which may occur is that the local application may wish to display textual labels large enough such that the user can read them, or a border may be applied which clips the textual labels. The appearance definitions according to the embodiments described above are retrieved from the server (30) and applied without considering such things.

Therefore, it may be advantageous to address minimum and maximum values in the standard. It may also be advantageous for the local application on the client (10) to inform the server (30) about the minimum window size that is required in such a way that appropriate appearance definitions are retrieved for this minimum window size.

It should be noted that the above-mentioned embodiments illustrate rather than limit the invention, and that those skilled in the art will be able to design many alternative embodiments without departing from the scope of the appended claims.

For example, the embodiments refer to a single server (30), but the information content (70, 170, 177, 270, 275, 277) and downloadable content (80) may be distributed over a plurality of servers (30). It may also be advantageous to distribute a single information content, such as the first information content (170, 270) in portions over a plurality of servers.

The methods of the invention may encoded as program code within one or more programs, such that the methods are performed when these programs are run on one or more computers. The program code may also be stored on a computer readable medium, and comprised in a computer program product.

The platform upon which one of these programs is executed may be a stand-alone dedicated unit, or it may be a PC provided with program code, or software, for executing the methods of the invention, or as a hardware add-on for a PC. The platform may also be integrated into a portable electronic device, such as a PDA or mobile telephone.

The platform may be integrated into an apparatus for operating as a client to a server, whereby the server is connected to a communications network, the apparatus comprising:

an interface for connecting to the communications network (20);

a first retriever for retrieving a first information content (270) from the server (30) over the communications network (20), the first information content (270) comprising a placeholder;

a first output configured to display (50) the first information content (270) on a display;

a second retriever for retrieving a second information content (275) from the server, the second information content (275) comprising appearance definitions;

a third retriever for retrieving a third information content from the client (10), the third information content being generated and controlled by the client (10);

a second output configured to display (155) the third information content at a position in the display determined by the placeholder; and whereby the second output is configured to display (155) the third information content in the display according to the appearance definitions.

The apparatus may also be modified to further comprises the display.

Similarly, references to a communications network (20) should be interpreted broadly as a communications pathway between the client (10) and the server (30)—it may be as simple as a cable between two physical devices, or it may be comprise one or more networks connected by one or more devices, such as servers or routers.

The embodiments may also be modified such that control options are rendered in the display (55, 155) by the local application, allowing the functionality of the user interface to be determined and controlled by the client (10) and the “look and feel” to be determined by a service or content provider. Local applications such as a webcam control manager may then be run on the client to display (55, 155) controls such as pan, tilt, zoom, focus and aperture, whereby the controls fit with the look & feel of the encompassing CE-HTML page from the service or content provider.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage.

In summary the invention relates to a method for displaying information generated by a client (10) connected to a communications network. One of the possible solutions for preventing the switching by the user between display renderings is to employ scripting, such as javascript. However, this can lead to security and privacy concerns.

The method of the invention comprises retrieving and displaying a first information content comprising a placeholder; retrieving a second information content comprising appearance definitions; retrieving a third information content from the client, the third information content being generated and controlled by the client; displaying the third information content at a position in the display determined by the placeholder; and displaying the third information content according to the appearance definitions.

By separating the functional content from the “look and feel” content, the functional content may be provided by the client without it being visible or accessible to the service provider, but still allowing the service provider to maintain a consistent “look and feel”.

1. Method for displaying information generated by a client (10) connected to a communications network (20), comprising:
retrieving a first information content (270) from a server (30) over the communications network (20), the first information content (270) comprising a placeholder;
displaying (50) the first information content (270) on a display;
retrieving a second information content (275) from the server, the second information content (275) comprising appearance definitions;
retrieving a third information content from the client (10), the third information content being generated and controlled by the client (10);
displaying (155) the third information content at a position in the display determined by the placeholder; and
displaying (155) the third information content in the display according to the appearance definitions.

2. The method of claim 1, wherein the method further comprises:
retrieving instructions (277) from the server (30); and
executing the instructions (277) to retrieve the second information content (275) from the server (30).

3. The method of claim 2, wherein the instructions (277) comprise javascript.

4. The method of claim 1, wherein the first information content (270) comprises a markup language.

5. The method of claim 4, wherein the markup language is selected from the group consisting of HTML, CE-HTML, XML, SVG, and any combinations thereof.

6. The method of claim 1, wherein the placeholder comprises one or more HTML tags selected from the group consisting of object, param, div, iframe, and any combinations thereof.

7. The method of claim 1, wherein the placeholder comprises a HTML object tag and a MIME-type.

8. The method of claim 1, wherein the third information content comprises states generated by a local application selected from the group consisting of download manager, DRM agent, Personal Video Recorder, Personal TV channel manager, or any combination thereof.

9. A computer program comprising program code means for performing all the steps of claim 1, when said program is run on a computer.

10. A computer program product comprising program code means stored on a computer readable medium for performing the method of claim 1, when said program code is run on a computer.

11. Method for supplying information content to a client (10) connected to a communications network (20), comprising:
supplying a first information content (270) over the communications network (20), the first information content (270) being suitable for displaying (50) on a display and comprising a placeholder, the placeholder being suitable for determining the position in the display of a third information content, the third information content being generated and controlled by the client (10); and
supplying a second information content (275), the second information content comprising appearance definitions,
whereby the appearance definitions are configured to determine the appearance of the third information content on the display.

12. Method for supplying information content according to claim 10, the method further comprising:
supplying instructions (277) to the client (10);
receiving a request from the client (10) executing the instructions (277), and
supplying the second information content (275) in response to the request.

13. Apparatus for operating as a client to a server, whereby the server is connected to a communications network, the apparatus comprising:
an interface for connecting to the communications network (20);
a first retriever for retrieving a first information content (270) from the server (30) over the communications network (20), the first information content (270) comprising a placeholder;
a first output configured to display (50) the first information content (270) on a display;
a second retriever for retrieving a second information content (275) from the server, the second information content (275) comprising appearance definitions;
a third retriever for retrieving a third information content from the client (10), the third information content being generated and controlled by the client (10);
a second output configured to display (155) the third information content at a position in the display determined by the placeholder; and whereby the second output is configured to display (155) the third information content in the display according to the appearance definitions.

14. The apparatus of claim 12, whereby the apparatus further comprises the display.
